(19) United States
(12) Patent Application Publication
(10) Pub. No.: US 2012/0290212 A1
(43) Pub. Date: Nov. 15, 2012

(54) SYSTEM AND METHOD FOR HYDROCARBON PAY ZONE DEFINITION IN A SUBTERRANEAN RESERVOIR

(75) Inventor: Chengbing Liu, Katy, TX (US)

(73) Assignee: Chevron U.S.A. Inc, San Ramon, CA (US)

(21) Appl. No.: 13/467,540

(22) Filed: May 9, 2012

Related U.S. Application Data
(60) Provisional application No. 61/484,559, filed on May 10, 2011.

(51) Int. Cl. G01V 9/00; G06F 19/00

(52) U.S. Cl. 702/13

(57) ABSTRACT

The present invention is directed to methods and systems for defining hydrocarbon net pay zone using movable water volume estimates and hydrocarbon saturation uncertainty levels in lieu of fixed cut-offs to define the net pay zone.

### CROSS-REFERENCE TO RELATED APPLICATIONS

The present patent application claims priority to U.S. Patent Application Ser. No. 61/484,559 filed on May 10, 2011, entitled “System for Method for Hydrocarbon Pay Zone Characterization in a Subterranean Reservoir” and is related to U.S. patent application Ser. No. 12/880,453 (Attorney Docket No. T-8134) entitled “System and Method for Hydrocarbon Gas Pay Zone Characterization in a Subterranean Reservoir,” and U.S. patent application Ser. No. 12/880,436 (Attorney Docket No. T-8135) entitled “System and Method for Sweet Zone Identification in Shale Gas Reservoirs,” which are hereby incorporated by reference in their entireties.

### FIELD OF THE INVENTION

The present invention relates generally to methods and systems for defining hydrocarbon pay zones in a subterranean reservoir, and in particular methods and systems for identifying and classifying net pay zones in tight gas reservoirs.

### BACKGROUND OF THE INVENTION

Conventional workflows have an important role in resources and reserves quantification of any play in the oil and gas industry. Such workflows typically include two main steps: quantification of reservoir properties, such as porosity, saturation, etc., and pay zone definition. Reservoir property quantification is required for resource estimation, and for providing an input for pay zone definition. Pay zone definition is required for determining zones of interest suitable for perforation and stimulation in order to induce production, and for reserves estimation. Without accurate pay definition, the quantified reservoir properties may not correctly reflect an ability to produce the hydrocarbons contained in a reservoir. More precise definition of net pay zone can improve the important aspects in various plays, including horizontal well placement, perforation and stimulation interval selection, and resources/reserves booking. This is especially true in the tight, gas-bearing, shale sand reservoirs.

Conventional approaches to defining pay zones have been based on fixed reservoir properties cut-off values. However, disadvantages of cut-off based pay definition methods may result in (a) overlooking “difficult to characterize pay zones,” and/or (b) picked pay zones that produce mainly water due to high movable water saturation.

FIG. 1 illustrates some shortcomings of conventional cut-off based pay definition method. The figure shows a hydrocarbon cut-off 10 relative to two subterranean areas of interest: a first area 20 having a non-movable bound water zone 22 and a movable hydrocarbon fluid zone 12, and a second area 30 having a non-movable bound water zone 32, a movable fluid zone 31 having a movable water zone 33 and a movable hydrocarbon fluid zone 12. Assuming the cut-off for hydrocarbon saturation is 0.4, any reservoir interval (to the right of the cut-off 10) with hydrocarbon (HC) saturation>0.4 would be picked as pay zone. Pay definition according to this method however has two disadvantages: (1) a reservoir interval such zone 40 in the first area 20 would be missed where hydrocarbon saturation does not meet the cut-off, but still produces only hydrocarbons with economic rate due to zero movable water saturation; and (2) a reservoir interval such as zone 50 in the second area 30 would be picked as pay where hydrocarbon saturation meets the cut-off but mainly produces water due to high movable water saturation.

As such, the need exists for a more reliable way of determining net pay that does not rely on the shortcomings of cut-off based approaches.

### SUMMARY OF THE INVENTION

A method is provided for determining hydrocarbon net pay zone using a log-based method which uses both movable water volume estimates and hydrocarbon saturation uncertainty level in lieu of fixed cut-offs to define the net pay zone. In one embodiment, the method further includes the step of classifying the pay zone into a first class pay zone and a second class pay zone.

In another embodiment, a system for defining a hydrocarbon pay zone in a subterranean reservoir includes a data source for accessing one or more reservoir characteristics, and a computer processor, in communication with the data source, configured to receive the reservoir characteristics and to execute a computer executable code responsive to the reservoir characteristics. The computer executable code includes: a first program code for determining a hydrocarbon saturation for a reservoir interval of interest within the subterranean reservoir, a second program code for determining an uncertainty level of the hydrocarbon saturation; a third program code for determining a movable water volume within the reservoir interval of interest; and a fourth program code defining an overall pay zone for the reservoir interval of interest based in part on the movable water volume, the hydrocarbon saturation, and the uncertainty level of the hydrocarbon saturation.

Advantageously, the present invention can be used to for more accurate pay zone determination and better decisions for horizontal well placement, perforation/stimulation zone selection, and resources/reserves booking in any plays in the oil and gas industry.

### BRIEF DESCRIPTION OF THE DRAWINGS

A description of the present invention is made with reference to specific embodiments thereof as illustrated in the appended drawings. The drawings depict only typical embodiments of the invention and therefore are not to be considered limiting of its scope.

FIG. 1 is a diagram that illustrates shortcomings of a conventional cut-off based pay definition method.

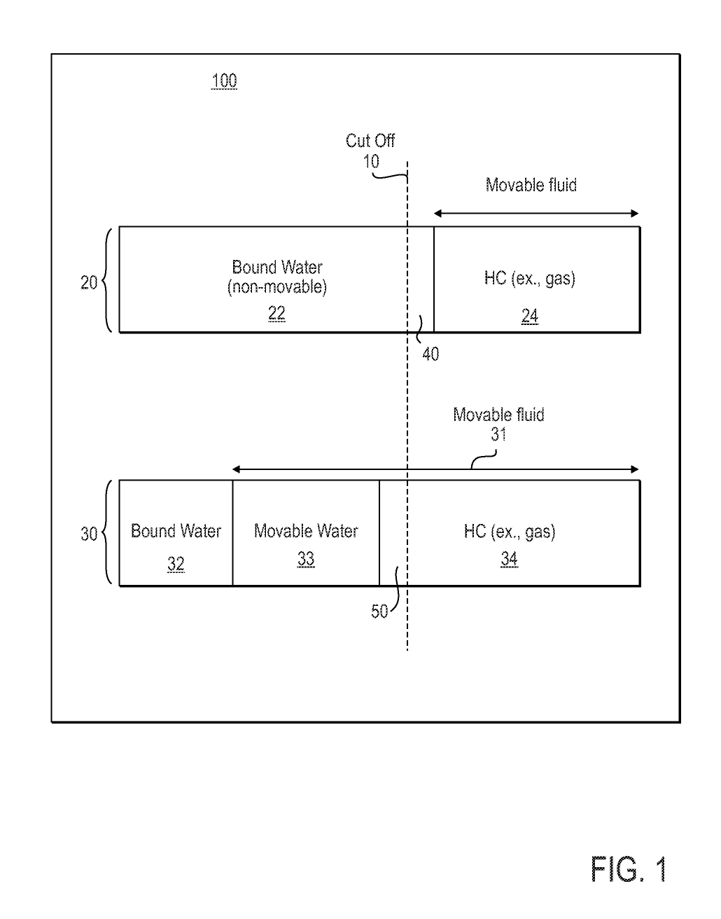

FIG. 2 is a diagram showing an exemplary method for characterizing hydrocarbon pay zones in accordance with the present invention.

FIG. 3 is a diagram showing generally how movable water may be determined in accordance with the present invention.

FIG. 4 is a diagram showing how to define a hydrocarbon pay zone based on movable water and uncertainty level dual concepts.

FIG. 5 is a schematic diagram of an exemplary system for characterizing hydrocarbon pay zones in accordance with the present invention.

### DETAILED DESCRIPTION OF THE INVENTION

Embodiments of the present invention for characterizing reservoir formation evaluation uncertainty are now described with reference to the appended drawings. The invention can be practiced as any one of or combination of hardware and software, including but not limited to a system (including a computer processor), a method (including a computer implemented method), an apparatus, an arrangement, a computer readable medium, a computer program product, a graphical user interface, a web portal, or a data structure tangibly fixed in a computer readable memory. Computer program functions can be distributed in among various modules or configurations, and such modules or configurations are considered to be within the scope of the present invention. An article of manufacture for use with a computer processor, such as a CD, pre-recorded disk or computer program storage medium having program code residing therein, also falls within the scope of the present invention.

Applications of the present invention include but are not limited to the characterization of porosity, saturation, fluid volume, permeability, etc., in a subterranean hydrocarbon reservoir. The appended drawings illustrate only typical embodiments of the present invention and therefore are not to be considered limiting of its scope and breadth.

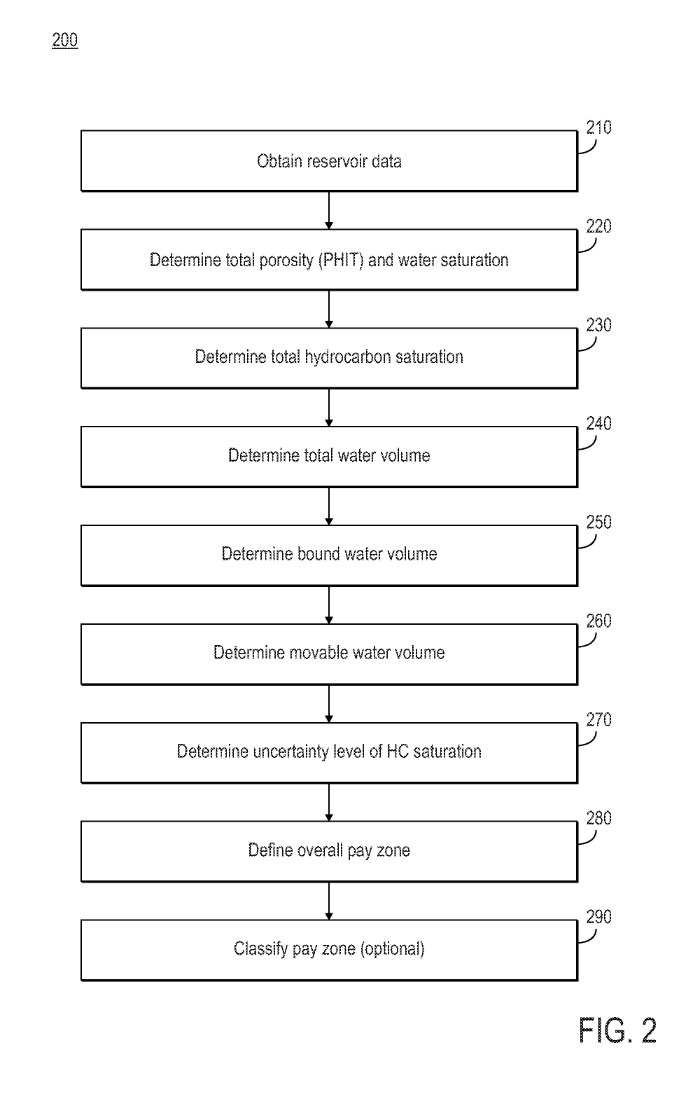

FIG. 2 shows an exemplary method 200 for hydrocarbon pay zone characterization in accordance with an embodiment of the present invention. The method 200 first includes the step 210 of obtaining or determining hydrocarbon reservoir characteristics from a data storage device, a reservoir model, measurement device or other information source. Reservoir characteristics may be measured, derived, computed, determined or otherwise obtained from well logs and core data, which may include by way of example, gamma ray, caliper, bulk density, neutron porosity, induction resistivity, formation pressure, nuclear magnetic resonance, and sidewall core data. Step 210 can further include the determination of a reservoir indicator (RNR, “Reservoir/No Reservoir”) based on lithology, porosity, permeability, movable fluid volume and/or any other suitable reservoir properties.

Next, a total porosity (PHIT) is determined, step 220, which in one embodiment can be based on neutron-density or any other known measurements or methods. Using a “dual water” or other suitable method, total water saturation (S_{wt}) can then be used to determine total hydrocarbon (HC) saturation (S_{hc}) in accordance with the equation S_{hc}=1−S_{wt}, step 230. Step 240 is then performed to obtain total water volume (TMV), e.g., TWV=PHIT*S_{wt}, and step 250 to obtain bound water volume (BWV). Step 250 can be based on nuclear magnetic resonance (NMR) or any other known measurements or methods. Step 260 is then preformed to obtain a movable water volume (MWV), e.g., MWV=TWV−BWV, i.e., movable water volume equals total water volume minus bound water volume.

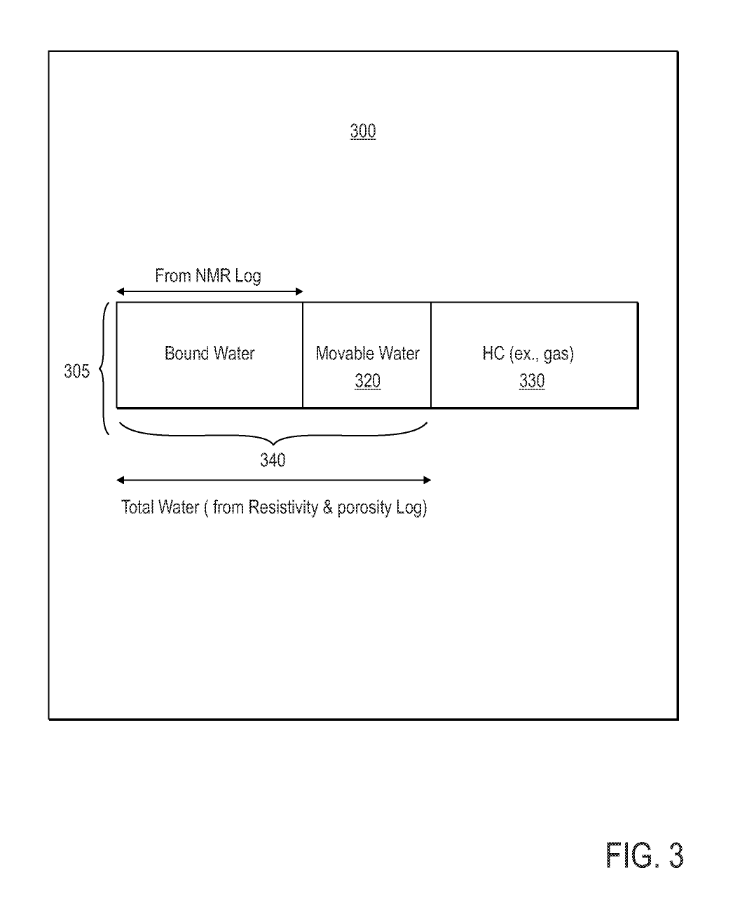

FIG. 3 is a diagram showing generally how movable water may be determined in accordance with the present invention. FIG. 3 shows an area of interest 200 having a non-movable bound water zone 310, a movable water zone 320 and a movable hydrocarbon zone 330. In one embodiment the volume of water (BMW) in the non-movable bound water zone 310 can be determined using NMR logs, and resistivity and/or porosity logs can be used to determine a total volume of water (TMV) in zone 340. As such, the movable water volume MWV can be determined. Note, if movable water volume=0, any HC in a HC-bearing reservoir can be considered as producible.

Referring again to FIG. 2, step 270 is then performed to determine the uncertainty level of HC saturation (S_{hc}_{_{—}}UNCL). In one embodiment, the uncertainty (i.e., noise) level associated with HC saturation and other properties can be estimated by Monte Carlo or other suitable statistical methods based on reservoir properties and their measurement errors. If HC saturation is found to be greater than its noise level, e.g., S_{hc}>S_{hc}_{_{—}}UNCL, then the HC saturation is considered as real and reliable signal. A similar method can be applied to determine a noise level for the volume of movable water (MWV noise level).

Step 280 is then performed to characterize or define or identity a reservoir interval of interested as a pay zone. In one embodiment, an overall pay zone flag (PNP or “Pay Non-Pay”) indicative of whether or not a reservoir interval has potential economic value is determined for the reservoir interval of interest. PNP in one embodiment is based on the reservoir flag (RNR), movable water volume (MWV), HC saturation (S_{hc}) and uncertainty level of HC saturation (S_{hc}_{_{—}}UNCL) using the following logic: PNP=1 if (1) RNR==1, and (2) MWV<MWV noise level, and (3) S_{hc}>S_{hc} noise level. In further accordance with this logic, the “Reservoir/No Reservoir” flag is set to “1” (Reservoir) if porosity, permeability or other selected reservoir property satisfies a predetermined threshold condition. If the movable water noise volume is less than the movable water noise level, then the hydrocarbon saturation is compared to the hydrocarbon saturation noise level. If the hydrocarbon saturation exceeds the hydrocarbon saturation noise level, then the “Pay/No Pay” flag is set to “1” (Pay).

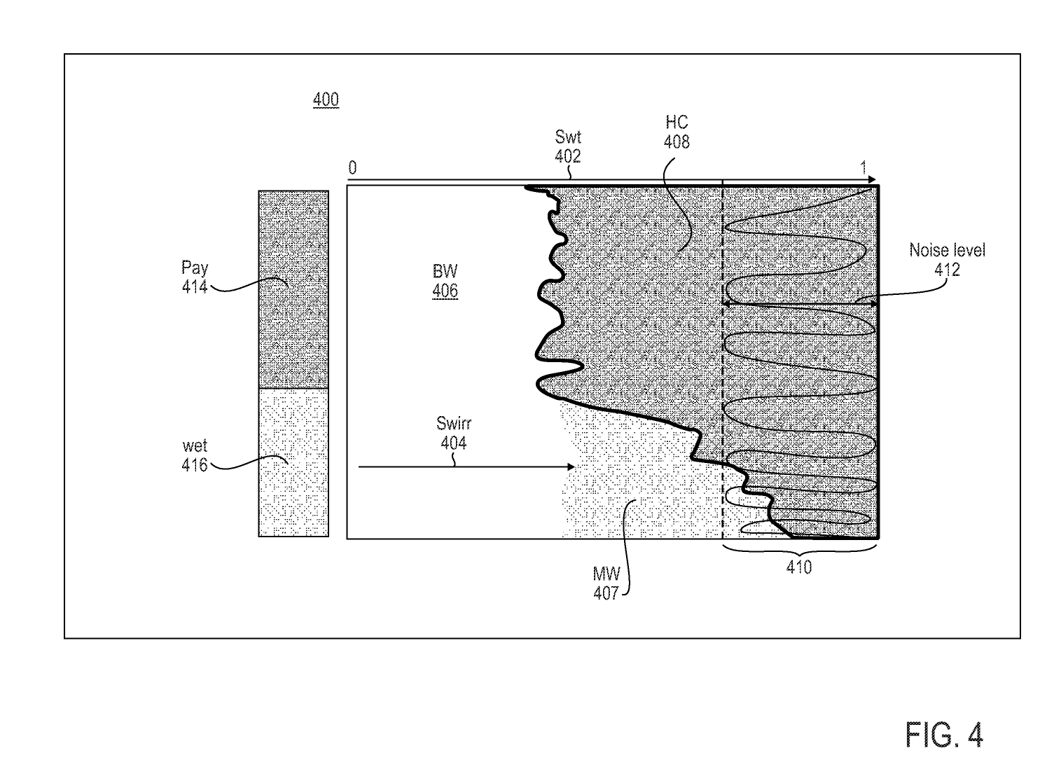

FIG. 4 is a diagram 400 illustrating an overall pay zone PNP based on movable water and uncertainty level dual concepts. The diagram represents a reservoir interval of interest for which water saturation 402 (horizontal axis) is plotted (shown in black as S_{wt}) as a function of depth (vertical axis). The interval includes a bound water volume 406, movable water volume 407 and hydrocarbon volume 408. A noise level is shown by 410, which includes amplitude 412, and which may include one or both noise levels for hydrocarbon saturation, water saturation and/or movable water volume. S_{wrr} denotes irreducible water saturation. In accordance with the above-described logic, an overall pay zone 414 (PNP) is determined in part based on a movable water volume, a hydrocarbon saturation (or alternatively water saturation), and an uncertainty level of the hydrocarbon saturation (or alternatively an uncertainty level of the water saturation.

Optionally, the overall pay zone can be further classified into a first class pay zone (PNP_C1) and a second class pay zone (PNP_C2), step 290. A “first class pay zone” refers to a sub-interval within the overall pay zone which also is picked by the traditional cut-off, i.e., it usually is the “easy to characterize” pay zone because at that depth where noise is not an issue and meets predetermined cut-off criteria, e.g., permeability, porosity, shale volume, etc. A “second class pay zone” refers to a sub-interval within the overall pay zone which is not picked by the cut-off, and which may be considered to be the “difficult to characterize pay zone.” The first and second class pay zones can be defined in accordance with the following logic: PNP_C1=1 if PNP=1 and S_{hc}>cut-off; and PNP_C2=1 if PNP==1& PNP_C1=0. In one embodiment, the cut-off is selected by a user having knowledge about the reservoir. Advantageously, the present invention allows for identification of additional pay intervals that are difficult to characterize with conventional methods, e.g., pure cut-off method.

Step 290 not only identifies all the “easy to characterize” and “difficult to characterize” pay zones, but also avoids picking zones that are hydrocarbon bearing but mainly produce water due to high movable water saturation.

The method of the present invention described above with reference to FIG. 2 is especially useful for use in connection with hydrocarbon reservoirs having tight gas sands with one or more of the following formation properties: porosity range of 5˜24%; permeability range of 0.05˜5 md; and gas saturation range of 0˜90% (avg. 50%). The method of the present invention can significantly increase both production and reserves. In one example, a total 4406.4 ft of extra “difficult to characterize pay zones” were identified in 29 wells at Site A, thus increasing the gas resource at Site A by 118 BCF and gas reserves by 11.8 BCF. At least five wells of these wells were identified as opportunities. Otherwise, the five wells would have been plugged and abandoned, and estimated $11 M US dollars of production would have been lost as a result.

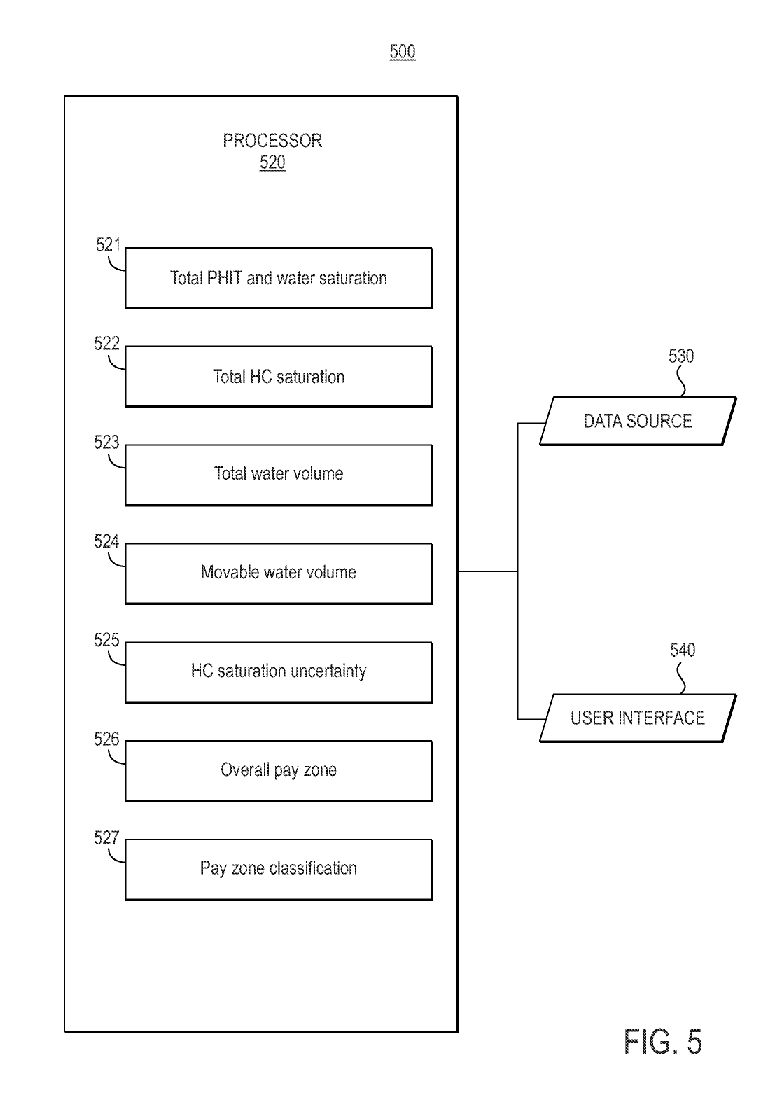

FIG. 5 is a schematic diagram of an exemplary system 500 for characterizing hydrocarbon pay zones in accordance with the method described with reference to FIG. 2. Referring to FIG. 5, the system includes a data source 530 for accessing one or more reservoir parameters. The data source 530 can be an electronic database, reservoir model or other information source that provides reservoir properties. The data source 530 is operatively in communication with a computer processor 520, which is configured to receive the reservoir properties and to execute a computer executable code responsive to the reservoir parameters. The computer executable code includes a first program code 521 for determining a total porosity based at least on one of the reservoir parameters; a second program code 522 for determining a total hydrocarbon saturation; a third program code 523 for determining a total water volume based at least on the total porosity and the total water saturation; a fourth program code 524 for determining a movable water volume; a fifth program code 525 for determining an uncertainty level of the total hydrocarbon saturation; and a sixth program code 526 for determining an overall pay zone based in part on the movable water volume, the total hydrocarbon saturation, and the uncertainty level of the total hydrocarbon saturation.

Optionally, the system 500 includes a seventh program code 527 to classify the overall pay zone into a first class pay zone and a second class pay zone in accordance with step 290 of FIG. 2.

In addition to the embodiments of the present invention described above, further embodiments of the invention may be devised without departing from the basic scope thereof. For example, it is to be understood that the present invention contemplates that one or more elements of any embodiment can be combined with one or more elements of another embodiment. It is therefore intended that the embodiments described above be considered illustrative and not limiting, and that the appended claims be interpreted to include all embodiments, applications and modifications as fall within the true spirit and scope of the invention.

What is claimed is:

1. A computer-implemented method for defining a hydrocarbon pay zone in a subterranean reservoir, comprising:
determining, using a computer, hydrocarbon saturation for a reservoir interval of interest within the subterranean reservoir;
determining, using the computer, an uncertainty level of the hydrocarbon saturation;
determining, using the computer, a movable water volume within the reservoir interval of interest;
defining, using the computer, the hydrocarbon pay zone for the reservoir interval of interest based in part on the movable water volume, the hydrocarbon saturation, and the uncertainty level of the hydrocarbon saturation.

2. The computer-implemented method of claim 1, further comprising classifying, using the computer, the overall pay zone into a first class pay zone and a second class pay zone.

3. The computer-implemented method of claim 2, wherein the classifying step comprises defining the first class and second class pay zones based on a cut-off criteria.

4. A computer-implemented method for defining a hydrocarbon pay zone in a subterranean reservoir, comprising:
accessing one or more reservoir characteristics;
determining, using a computer a porosity, water saturation and bound water volume based at least one of the reservoir characteristics;
determining, using the computer, a hydrocarbon saturation based on the water saturation;
determining, using the computer, a total water volume based at least on the porosity and water saturation;
determining, using the computer, a movable water volume based on the a total water volume and bound water volume;
determining, using the computer, an uncertainty level of the hydrocarbon saturation; and
defining, using the computer, the hydrocarbon pay zone based in part on the movable water volume, the hydrocarbon saturation, and the uncertainty level of the hydrocarbon saturation.

5. The computer-implemented method of claim 4, further comprising classifying, using the computer, the hydrocarbon pay zone into a first class pay zone and a second class pay zone.

6. The computer-implemented method of claim 5, wherein the classifying step comprises defining the first class and second class pay zones based on a cut-off criteria.

7. A system for defining a hydrocarbon pay zone in a subterranean reservoir, comprising:
a data source for accessing one or more reservoir characteristics;
a computer processor in communication with the data source, the processor configured to receive the reservoir characteristics and to execute a computer executable code responsive to the reservoir characteristics, the computer executable code comprising:
a first program code for determining a hydrocarbon saturation for a reservoir interval of interest within the subterranean reservoir;
a second program code for determining an uncertainty level of the hydrocarbon saturation;
a third program code for determining a movable water volume within the reservoir interval of interest; and
a fourth program code defining the hydrocarbon pay zone for the reservoir interval of interest based in part on the movable water volume, the hydrocarbon saturation, and the uncertainty level of the hydrocarbon saturation;

8. The system of claim 1, further comprising a seventh program code to classify the hydrocarbon pay zone into a first class pay zone and a second class pay zone.

9. An article of manufacture comprising computer usable media having a computer readable program code embodied therein, the computer readable program code adapted to be executed to implement a method for defining a hydrocarbon pay zone in a subterranean reservoir, the method comprising:
determining, using a computer, a hydrocarbon saturation for a reservoir interval of interest within the subterranean reservoir;
determining, using the computer, an uncertainty level of the hydrocarbon saturation;
determining, using the computer, a movable water volume within the reservoir interval of interest; and
defining, using the computer, the hydrocarbon pay zone for the reservoir interval of interest based in part on the movable water volume, the hydrocarbon saturation, and the uncertainty level of the hydrocarbon saturation.

10. The article of manufacture of claim 5, wherein the computer readable program code is further adapted to be classify the hydrocarbon pay zone into a first class pay zone and a second class pay zone.
